(19) United States
(12) Patent Application Publication
(10) Pub. No.: US 2025/0091734 A1
(43) Pub. Date: Mar. 20, 2025

(54) PROPULSION AND MANIPULATION SYSTEM USING FORCE BEAMS

(71) Applicant: Alexandre TIAGO BAPTISTA DE ALVES MARTINS, Brasília (BR)

(72) Inventor: Alexandre TIAGO BAPTISTA DE ALVES MARTINS, Brasília (BR)

(21) Appl. No.: 18/725,934

(22) PCT Filed: Nov. 9, 2022
(86) PCT No.: PCT/BR2022/050428

§ 371 Date: Jul. 1, 2024

(30) Foreign Application Priority Data
Jan. 10, 2022 (BR) 1020220004633

(51) Int. Cl. B64G 1/40; H02N 11/00

(52) U.S. Cl. CPC B64G 1/417; H02N 11/006

(57) ABSTRACT

The present invention relates to a new form of air, land, underwater, or space propulsion, achieved by the use of suitable electromagnetic interactions. When using a longitudinal electromagnetic field emitter (1), which emits longitudinal electric or magnetic fields, with asymmetric electric or magnetic field derivatives, through space in the direction of element (2), optionally focused or amplified by element (3), we develop directional forces in elements (1) and (2). This is possible due to a new electromagnetic propulsion mechanism that uses the conservation of total momentum where the sum of mechanical momentum and field momentum must always be conserved resulting in a constant and zero total sum of the two components, where the variation in electric or magnetic field momentum will generate a corresponding change in the mechanical momentum of the assembly, thus generating propulsion forces.

The present invention relates to a new form of propulsion and remote mass manipulation with the capability to generate aerial, terrestrial, underwater, or space manipulation or propulsion, achieved through the use of suitable electromagnetic interactions, which will be explained below.

Recent experiments with longitudinal electric and magnetic fields pulsed in an asymmetric manner have shown the existence of a new type of electromagnetic propulsion. This is possible due to the conservation of total momentum, where the sum of mechanical momentum and the momentum of the electric or magnetic field must always be conserved, resulting in a constant and total null sum of the two components. The variation in the momentum of the electric or magnetic field will generate a corresponding change in the mechanical momentum of the mass where these fields are applied, thus generating propulsion forces.

The current state of the art in inertialess propulsion is given by the American U.S. Pat. No. 10,144,532 (2018) by Salvatore Cezar Pais. In this patent, a propulsion system is described that uses transverse microwave waves propagated parallel to an electrically charged metallic surface in order to vibrate it and generate propulsion. The propulsion systems proposed in the present patent are different and make use of simpler systems than those described by Salvatore Pais. We will now proceed to describe how the propulsion systems, inertia attenuation, and force field generation of the present patent work.

Considering first, in this context, applications of electric fields, we see that when the atoms of a dielectric material are subjected to an external electric field, they acquire a potential electric energy density Uₚₑ given by:

$${U}_{p e} = - P \cdot E [ \frac{J}{{m}^{3}} ] \qquad ( 1 )$$

Where E is the applied external electric field and P is the atomic polarization vector of a linear dielectric:

$$P = {ε}_{0} {χ}_{e} E = {ε}_{0} ( {ε}_{r} - 1 ) E \qquad ( 2 )$$

With susceptibility χₑ, vacuum permittivity so, and relative electric permittivity εᵣ. The electric energy density U_{E}, considering the polarization effects of matter is:

$${U}_{E} = \frac{E \cdot D}{2} [ \frac{J}{{m}^{3}} ] \qquad ( 3 )$$

Which can be rewritten as:

$${U}_{E} = \frac{E \cdot ( {ε}_{0} E + P )}{2} = \frac{1}{2} [ {ε}_{0} E \cdot E + E \cdot P ] [ \frac{J}{{m}^{3}} ] \qquad ( 4 )$$

This equation represents the sum of the electric energy densities in the vacuum and within the matter. The temporal variation of the energy density ∂U_{E}/∂t will be:

$$\frac{\partial {U}_{E}}{\partial t} = \frac{1}{2} \frac{\partial }{\partial t} [ {ε}_{0} E \cdot E + E \cdot P ] = {ε}_{0} E \cdot \frac{\partial E}{\partial t} + E \cdot \frac{\partial P}{\partial t} [ \frac{J}{{m}^{3}} \frac{1}{s} ] \qquad ( 5 )$$

The relationship between the linear momentum p_{fields} and the energy u_{fields} for electromagnetic fields is given by:

$${p}_{fields} = \frac{{u}_{fields}}{c} [ kg \cdot m \cdot {s}^{- 1} ] \qquad ( 6 )$$

Where c is the propagation speed of electromagnetic fields or waves. The last equation for the linear momentum of electromagnetic fields uses the equivalence between energy and matter initially established by Einstein. The total conservation of momentum between fields (p_{fields}) and matter(pₘₐₜₜₑᵣ) requires that:

$${p}_{matter} + {p}_{fields} = 0 ⇒ {p}_{matter} = - {p}_{fields} = - \frac{1}{c} {u}_{fields} [ kg \cdot m . {s}^{- 1} ] \qquad ( 7 )$$

According to Newton's laws, force is proportional to the temporal variation of linear momentum, providing the following equation for force density:

$${f}_{matter} = \frac{d {P}_{matter}}{d t} = - \frac{d {P}_{fields}}{d t} = - \frac{1}{c} \frac{{dU}_{fields}}{d t} [ \frac{N}{{m}^{3}} ] \qquad ( 8 )$$

Where fₘₐₜₜₑᵣ is the force density developed in matter, Pₘₐₜₜₑᵣ is the linear momentum density of matter, P_{fields} is the linear momentum density of fields, and U_{fields} is the energy density of fields. We take the approximation of considering the speed of light constant. Equation (8) represents the total balance between force densities that must exist due to the conservation of the total linear momentum between the considered matter and fields, that is:

$$\frac{d {P}_{matter}}{d t} + \frac{d {P}_{fields}}{d t} = 0 [ \frac{N}{{m}^{3}} ] ⇒ \frac{d {P}_{matter}}{d t} + \frac{1}{c} \frac{{dU}_{fields}}{d t} = 0 [ \frac{N}{{m}^{3}} ] \qquad ( 9 )$$

For electric fields applied to dielectrics, using Equations (1) and (4), the electric field linear momentum density P_{E} can be written as:

$${P}_{E} = \frac{{U}_{E}}{c} = - \frac{E \cdot D}{2 c} = - \frac{{ε}_{0}}{2 c} E \cdot E - \frac{{ε}_{0} ( {ε}_{r} - 1 )}{2 c} E \cdot E \qquad ( 10 )$$

Where we use the definition of the polarization vector as given in Equation (2), and also that the interaction potential energy is negative for dielectrics subjected to electric fields, as shown in Equation (1). This negative momentum means that the momentum of electric fields is directed in the opposite direction to the applied electric field vector, as also confirmed by experimental observations. From Equations (8) and (10), the electrical displacement force becomes:

$${f}_{matter} = \frac{d {P}_{matter}}{d t} = - \frac{d {P}_{E}}{d t} = \frac{{ε}_{0}}{c} E \cdot \frac{\partial E}{\partial t} + \frac{E}{c} \cdot \frac{\partial P}{\partial t} = \frac{{ε}_{0}}{c} E \cdot \frac{\partial E}{\partial t} + \frac{E}{c} \cdot {J}_{P} [ \frac{N}{{m}^{3}} ] \qquad ( 11 )$$

Where Jₚ is the displacement polarization current density:

$${J}_{p} = ( {ε}_{r} - 1 ) {ε}_{0} \frac{\partial E}{\partial t} = \frac{\partial P}{\partial t} \qquad ( 12 )$$

The total force F_{Total} developed in the bulk dielectric of volume V will be directly proportional to the rate of pulses per second γₚᵤₗₛₑ:

$${F}_{Total} = {γ}_{pulse} V \sqrt{{ε}_{r} {μ}_{r}} ( \frac{{ε}_{0}}{c} E \cdot \frac{\partial E}{\partial t} + \frac{E}{c} \cdot \frac{\partial P}{\partial t} ) [ N ] \qquad ( 13 )$$

Where we add the term \sqrt{εᵣμᵣ} due to the change in the speed of light inside the dielectric or magnetic material. Equation (13) also includes forces related to the variation in the Polarization P (Equation (2)) of the dielectric material used, that is, it includes variations over time of two different variables: both the applied electric field E and the relative electrical permittivity εᵣ of the dielectric used. Using Equation (2) in Equation (13), we can also write that:

$$\frac{E}{c} \cdot \frac{\partial P}{\partial t} = {ε}_{0} \frac{E}{c} \cdot \frac{\partial [ ( {ε}_{r} - 1 ) E ]}{\partial t} .$$

Therefore, in the final calculation of the force in Equation (13), we will have to consider the effects of temporal changes in both the electric field E and the relative electrical permittivity εᵣ. In this way, the advantages of using dielectric materials where the relative electrical permittivity varies over time in synchrony with the applied electric field (nonlinear dielectrics) becomes clear.

If a single asymmetric voltage pulse generates a force of 1 N, then if we apply a rate of 1000 pulses per second, the total force generated will be 1000 N. In this way we can generate a variety of force magnitudes using the same physical system.

The second term of Equation (13) represents the temporal version of the Kelvin electric gradient force equation f_{KE}, given by:

$${f}_{KE} = P \cdot ∇ E [ \frac{N}{{m}^{3}} ] \qquad ( 14 )$$

Where dielectrics are attracted in the direction of the gradient of applied external electric fields. When using the equation for the propagation of electric fields in space:

$${∇}^{2} E = {ε}_{0} {μ}_{0} \frac{{\partial }^{2} E}{\partial {t}^{2}} = \frac{1}{{c}^{2}} \frac{{\partial }^{2} E}{\partial {t}^{2}} \qquad ( 15 )$$

And if we take the square root of this last equation, we obtain:

$$∇ E = \frac{1}{c} \frac{\partial E}{\partial t} \qquad ( 16 )$$

Which gives us the spatial gradient of the electric field in terms of the temporal variation of the field and its speed. By substituting Equation (16) into Equation (14), we recover a simplified version of the electrical displacement force density f_{DE}, as given by the second term of Equation (13):

$${f}_{DE} = \frac{P}{c} \cdot \frac{\partial E}{\partial t} = {ε}_{0} ( {ε}_{r} - 1 ) \frac{E}{c} \cdot \frac{\partial E}{\partial t} [ \frac{N}{{m}^{3}} ] \qquad ( 17 )$$

This equation is simply a temporal variation (never before developed in these terms) of a long-known equation, where forces are developed in dielectrics due to the spatial gradient of the electric field generated in our case by the temporal variation of electric fields. This result is one more confirmation of the momentum associated with the electric field in the opposite direction to the electric vector, confirming our initial derivation, Equation (13), in terms of conservation of field energy and total conservation of the sum of mechanical and field momentum.

Equations (11) and (13) denote an electrical displacement and polarization force that acts on dielectrics, which is completely electrical in origin. However, when we adopt the perspective given by the conservation of total momentum, we see that this force is generated by interaction with the momentum of space-time itself, which is equivalent to the momentum of the electric or magnetic field. From this perspective, this force could also be called the “space warp” force, due to the direct interaction with space-time and its deformation, that is, the change in its momentum.

If the initial and final electric field derivatives are symmetric, then no force will be generated. Equation (13) only develops directional forces when E·∂E/∂t is asymmetric. Equation (13) is unique because it is directly proportional to E·∂E/∂t, not requiring temporal integration as done for Lorentz forces and others that are initially formulated in steady state. A great advantage of the electrical displacement or polarization force is that the shorter the applied pulse, the stronger the force generated, due to the fact that it is a time-dependent force where the momentary gradient of the electric field propagated in the dielectric increases with the rapidness of the pulse. In this way, the propagation of a single pulse of longitudinal electric field will directly generate the force given by Equation (13).

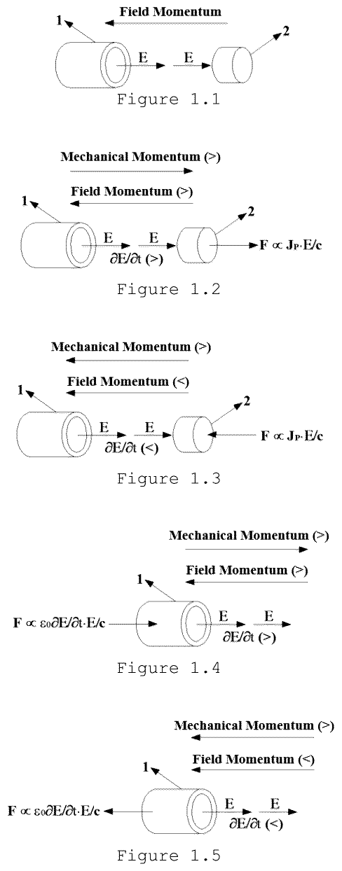

Let us consider an emitter of longitudinal electromagnetic fields 1, which emits, for example, longitudinal electric fields at a distance in the direction of element 2 (FIG. 1.1)), which could be a dielectric, conductor, or magnetic material with characteristics that will be detailed later. If we consider the instant when the electric field E emitted externally by element 1 is directed to the right, then we see that the electric field moment is directed in the opposite direction to the electric field vector E (FIG. 1.1)).

During the process in which the electric field directed to the right increases, this will generate a gain in mechanical linear momentum to the right, in the opposite direction to the linear momentum of the applied field (so that the total sum of the momentum and its variation is zero), generating a mechanical force on element 2 to the right, proportional to the temporal variation of the electric field moment as it increases (FIG. 1.2)).

Let us now consider the case in which the electric field E emitted by element 1 and directed to the right decreases over time (FIG. 1.3)). In this case, the electric field momentum decreases to zero and a gain in mechanical momentum is generated in element 2 to the left, in the same direction as the electric field momentum vector (FIG. 1.3)). It should be noted that element 1 will generate reaction forces within itself, in the same direction as the forces generated in element 2, only by emitting asymmetrically pulsed electric fields, but in this case the magnitude will be smaller due to the emission taking place in air or vacuum (FIGS. 1.4) and 1.5)). This process again reflects the conservation of linear momentum by equalizing the field momentum lost to the mechanical momentum gained from the initial momentum that was present in the field. In this way, we have conservation of total linear momentum through the dynamic exchange of linear momentum between physical matter and the fields, generating mechanical forces in elements 1 and 2 proportional to the rate of variation of the field momentum.

Using suitably constructed asymmetrically pulsed longitudinal electric field waves applied to elements 1 and 2, we are able to generate directional forces in either of the two directions longitudinal to the electric field, the magnitude of which increases with the frequency of the applied pulses according to Equation (13).

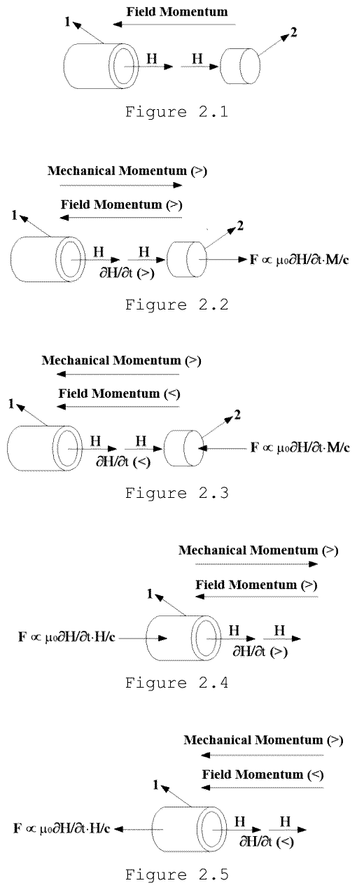

Let us now consider the case in which the emitter of longitudinal electromagnetic fields 1 emits longitudinal magnetic fields H at a distance in the direction of element 2 (FIG. 2.1)). We see in this case that when the atoms of a magnetic material are subjected to an external magnetic field, they acquire a potential magnetic energy density Uₚₘ given by:

$${U}_{pm} = - M \cdot B = - {μ}_{0} M \cdot ( H + M ) = - {μ}_{0} M \cdot H - {μ}_{0} M \cdot M [ \frac{J}{{m}^{3}} ] \qquad ( 18 )$$

Where B and H are respectively the magnetic field density and the applied magnetic field, μ₀ is the vacuum permeability and M is the atomic magnetization vector given by:

$$M = {χ}_{m} H = ( {μ}_{r} - 1 ) H \qquad ( 19 )$$

With susceptibility χₘ and relative magnetic permeability μᵣ. The magnetic energy density U_{M}, considering the polarization effects of matter by the external application of magnetic fields is:

$${U}_{M} = \frac{B \cdot H}{2} [ \frac{J}{{m}^{3}} ] \qquad ( 20 )$$

Which can be rewritten as:

$${U}_{M} = \frac{( {μ}_{0} H + {μ}_{0} M ) \cdot H}{2} = \frac{1}{2} [ {μ}_{0} H \cdot H + {μ}_{0} M \cdot H ] [ \frac{J}{{m}^{3}} ] \qquad ( 21 )$$

This equation represents the sum of the magnetic energy densities in the vacuum and inside matter. The temporal variation of the energy density ∂_{M}/∂t will be:

$$\frac{\partial {U}_{M}}{\partial t} = \frac{1}{2} \frac{\partial }{\partial t} [ {μ}_{0} H \cdot H + {μ}_{0} M \cdot H ] = {μ}_{0} H \cdot \frac{\partial H}{\partial t} + {μ}_{0} H \cdot \frac{\partial M}{\partial t} [ \frac{J}{{m}^{3}} \frac{1}{s} ] \qquad ( 22 )$$

For magnetic fields applied to magnetic materials, using Equations (6), (18) and (21), the magnetic field linear momentum density P_{M} can be written as:

$${P}_{M} = \frac{{U}_{M}}{c} = - \frac{B \cdot H}{2 c} = - \frac{1}{2 c} [ {μ}_{0} H \cdot H + {μ}_{0} M \cdot H ] \qquad ( 23 )$$

Where we use the definition of magnetic interaction potential energy which is negative for magnetic materials subjected to magnetic fields, as shown in Equation (18). This negative momentum means that the linear momentum of magnetic fields is directed in the opposite direction to the applied magnetic field vector, as also confirmed by experimental observations. From Equations (8) and (23), the magnetic force of displacement in matter becomes:

$${f}_{matter} = \frac{{d}_{matter}}{d t} = - \frac{d {P}_{M}}{d t} = \frac{{μ}_{0}}{c} H \cdot \frac{\partial H}{\partial t} + \frac{{μ}_{0}}{c} M \cdot \frac{\partial H}{\partial t} [ \frac{N}{{m}^{3}} ] \qquad ( 24 )$$

This equation consists of two terms, where the first term reflects the use of applications in air or vacuum with relative magnetic permeability of one, and the second term reflects the use of magnetic materials with relative magnetic permeability different from one. The total force F_{Total} developed in magnetic materials of volume V_{mag} will be directly proportional to the rate of pulses per second γₚᵤₗₛₑ:

$${F}_{Total} = {γ}_{pulse} {V}_{mag} \sqrt{{ε}_{r} {μ}_{r}} ( \frac{{μ}_{0}}{c} H \cdot \frac{\partial H}{\partial t} + \frac{{μ}_{0}}{c} M \cdot \frac{\partial H}{\partial t} ) [ N ] \qquad ( 25 )$$

Where we add the term \sqrt{εᵣμᵣ} due to the change in the speed of light inside the magnetic or dielectric material. Equation (25) also includes forces related to the variation in magnetization M(Equation (19)) of the magnetic material used in element 2, that is, it includes variations over time of two different variables: both the magnetic field H and the relative magnetic permeability μᵣ. Due to the inner product used in Equation (25), we can also write that:

$$\frac{{μ}_{0}}{c} M \cdot \frac{\partial H}{\partial t} = \frac{{μ}_{0}}{c} H \cdot \frac{\partial M}{\partial t} = \frac{{μ}_{0}}{c} H \cdot \frac{\partial [ ( {μ}_{r} - 1 ) H ]}{\partial t} .$$

Therefore, in the final calculation of the force in Equation (25), we will have to consider the effects of temporal change of both the magnetic field H and the relative magnetic permeability μᵣ. In this way, the advantages of using magnetic materials for element 2 where the relative magnetic permeability varies over time in synchrony with the applied magnetic field (nonlinear magnetic materials) becomes clear.

If a single pulse of asymmetric magnetic field generates a force of 1 N, then if we apply a rate of 1000 pulses per second, the total force generated will be 1000 N. In this way we can generate forces of wide magnitude using the same physical system.

The second term of Equation (25) represents the temporal version of the Kelvin spatial magnetic gradient force equation f_{KM}, given by:

$${f}_{KM} = {μ}_{0} ( M \cdot ∇ ) H [ \frac{N}{{m}^{3}} ] \qquad ( 26 )$$

Where magnetic materials are attracted in the direction of the gradient of the applied external magnetic fields. When using the equation for the propagation of magnetic fields in space:

$${∇}^{2} H = {ε}_{0} {μ}_{0} \frac{{\partial }^{2} H}{\partial {t}^{2}} = \frac{1}{{c}^{2}} \frac{{\partial }^{2} H}{\partial {t}^{2}} \qquad ( 27 )$$

And if we take the square root of this last equation, we obtain:

$$∇ H = \frac{1}{c} \frac{\partial H}{\partial t} \qquad ( 28 )$$

Which gives us the spatial gradient of the magnetic field in terms of the temporal variation of the field and its speed. By substituting Equation (28) into Equation (26), we recover a simplified version of the magnetic displacement force density f_{DM}, as given by the second term of Equation (25):

$${f}_{DM} = \frac{{μ}_{0}}{c} M \cdot \frac{\partial H}{\partial t} [ \frac{N}{{m}^{3}} ] \qquad ( 29 )$$

This equation is simply a temporal variation (never before developed in these terms) of a long-known equation, where forces are developed in magnetic materials due to the spatial gradient of the magnetic field generated in our case by the temporal variation of magnetic fields. This result is yet another confirmation of the momentum associated with the magnetic field in the opposite direction to the magnetic vector, confirming our initial derivation, Equation (25), in terms of conservation of field energy and total conservation of the sum of mechanical and field momentums.

Let us now reconsider an emitter of longitudinal electromagnetic fields 1, which emits longitudinal magnetic fields at a distance in the direction of element 2 (FIG. 2.1)). If we consider the instant when the magnetic field H emitted externally by element 1 is directed to the right, then we see that the magnetic field momentum is directed in the opposite direction to the magnetic field vector H (FIG. 2.1)). During the process in which the magnetic field directed to the right increases, this will generate a gain in mechanical linear momentum to the right, in the opposite direction to the linear momentum of the applied field (so that the total sum of the momentum and its variation is zero), generating a mechanical force on element 2 to the right, proportional to the temporal variation of the magnetic field momentum as it increases (FIG. 2.2)).

Let us now consider the case in which the magnetic field H emitted by element 1 and directed to the right decreases over time (FIG. 2.3)). In this case, the magnetic field momentum decreases to zero, generating a gain of mechanical momentum in element 2 to the left, in the same direction as the magnetic field momentum vector (FIG. 2.3)). It should be noted that element 1 will generate reaction forces within itself, in the same direction as the forces generated in element 2, only by emitting asymmetrically pulsed magnetic fields, but in this case the magnitude will be smaller due to the emission taking place in air or vacuum (FIGS. 2.4) and 2.5)).

As we can see in FIGS. 1 and 2, elements 1 and 2 will move in the direction necessary to satisfy the conservation of space-time's total momentum around them. Any acceleration generated by mechanical forces will feel forces of inertia, due to the relative movement of space-time opposite to the acceleration of the object, and where the momentum and temporal variation of the momentum of the involved mass and space-time must cancel each other according to Equations (7) and (9). As the force in the propulsion system of this patent is generated by direct interaction with space-time, where the electric or magnetic field momentum also corresponds to space-time momentum, then the generated forces will be produced without inertia, that is, without resistance of space-time. The same process happens for bodies accelerated by gravitational forces that directly modify space-time, which according to Einstein's theory of Relativity will not feel any force of inertia when accelerated by a gravitational field.

In this mass manipulation or propulsion system, teleportation will be generated when E·∂E/∂t, or B·∂B/∂t, or H·∂H/∂t, exceed a certain threshold value. The phenomenon occurs because the electric field E is proportional to the linear velocity of space-time through the relationship to the linear momentum of the electric field, which is equivalent to the linear momentum of space-time, as given by Equation (10). On the other hand, the magnetic field also has a linear momentum given by Equation (23), where in this case the variation of the magnetic field and its linear momentum will be proportional to the rotational speed of space-time (∇×E=−∂B/∂t). Regardless of the direction of the space-time velocity in relation to the electric field vector E, or magnetic field density B, we can observe that ∂E/∂t represents a linear acceleration of space-time, and ∂B/∂t a rotational acceleration of space-time, which behaves like a superfluid as explained in Einstein's theory of Relativity. As is known in fluid dynamics, under the name of supercavitation, when a fluid is accelerated above a certain limiting speed, then a phase change will occur in the fluid from the liquid to the gaseous phase, for example, dramatically decreasing the density of the fluid itself and consequently dramatically increasing the speed of propagation allowed through it.

In this way, applying a single pulse of extremely high magnitude, E·∂E/∂t, or B·∂B/∂t, or H·∂H/∂t, above a given transition value, teleportation will be generated in the same direction as the “space warp” force, Equations (13) or (25), where the distance covered in a single teleportation “jump/leap” will depend on the total magnitude of the used pulse. To generate teleportation and the displacement of masses without inertia, it is necessary to generate asymmetrically pulsed electric or magnetic fields, distributed completely or partially within or around the mass to be transported.

The present invention will now be described in detail, without limitation and by way of example, by means of preferred embodiments, represented in the attached drawings, in which:

FIG. 1 describes the theory of “space warp” or electrical displacement/polarization force that acts on elements 1 and/or 2, due to total conservation of electrical linear momentum.

FIG. 2 describes the theory of “space warp” or magnetic displacement/magnetization force that acts on elements 1 and/or 2, due to total conservation of magnetic linear momentum.

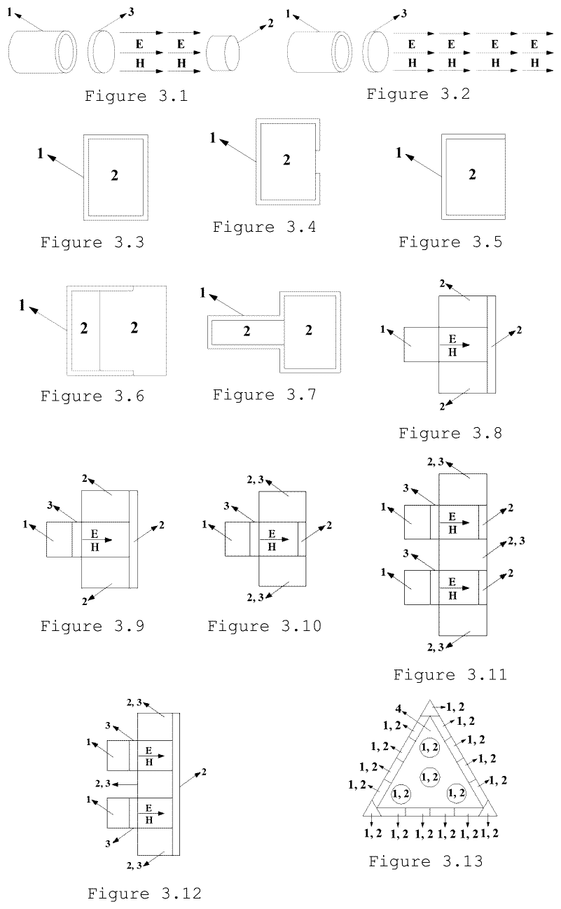

FIG. 3 represents several shapes for propulsion units.

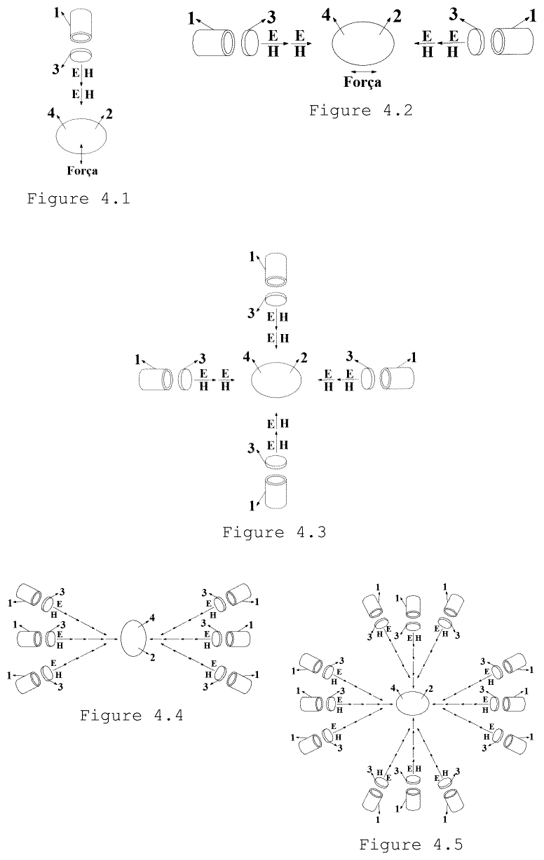

FIG. 4 represents various ways of applying manipulation units arranged externally around a mass.

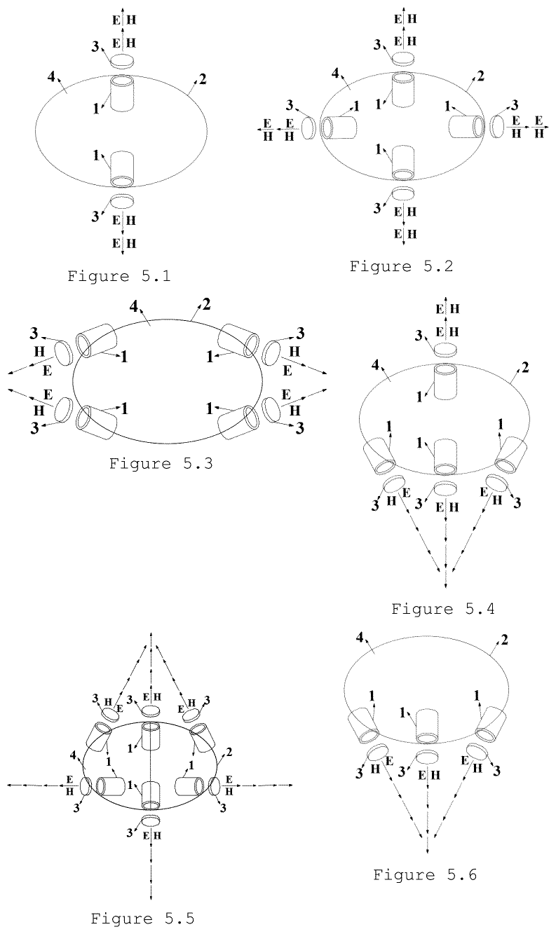

FIG. 5 represents various ways of applying propulsion units arranged inside or on the surface of a mass.

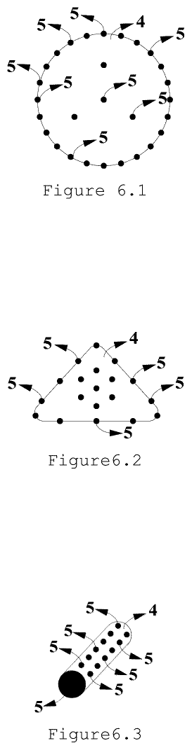

FIG. 6 represents various ways of applying propulsion units in structures with different geometries.

### DESCRIPTION OF THE PREFERRED EMBODIMENT

With reference to the figures, the preferred embodiment of the invention will now be described. In the attached figures, equal numbers correspond to equivalent components in different configurations. Each of the configurations we will describe results from a natural development of the previous one, using the same physical principles to generate the manipulation or propulsion forces described previously, being natural and different variations that complete and complement each other.

Our preferred configuration for mass manipulation or propulsion uses a longitudinal electromagnetic field emitter 1, which emits longitudinal electric or magnetic fields through space in the direction of element 2 (FIG. 3.1), which is mechanically fixed at some distance from element 1, developing forces in elements 1 and 2 (FIGS. 3.1) and 3.2)) according to Equations (13) and (25) (FIGS. 1 and 2). Element 2 may be at any distance from elements 1 or 3, including in physical contact with element 1 or 3, and may even be mechanically supported by elements 1 or 3.

An element 3 may optionally be used, which has the general function of amplifying longitudinal waves; or element 3 may function as an electromagnetic lens dispersing or on the contrary focusing the electrical or magnetic longitudinal waves into a well-defined beam with controlled aperture, focus and dispersion; or element 3 may control the phase of the emitted longitudinal waves for “phasing” purposes, or amplification of the power and energy emitted by the nonlinear sum of two or more beams; or element 3 can also transform transverse electromagnetic waves into longitudinal ones.

Until now, element 2 has been placed outside element 1, but it will also be possible to use element 2 directly inside element 1, where element 2 can be completely surrounded by element 1 (FIG. 3.3)), or partially surrounded, only with a small opening on one of the faces of element 1 (FIG. 3.4)), or where one of the faces of element 1 can be completely open (FIG. 3.5)), or where element 2 can be inserted inside element 1 only in partial form (FIG. 3.6)), and you can adapt its dimensions in order to be mechanically supported by elements 1 or 3. Element 2 may be differentiated, that is, the interior of element 1 may have a solid element 2 next to another lateral gaseous, vacuum, liquid, or solid element 2 (FIG. 3.6)), where the various components of elements 1 and/or 2 may have similar linear dimensions (FIG. 3.6)) or different along their length (FIG. 3.7)).

Another operating possibility could use an element 1 emitting asymmetric longitudinal pulses in the direction of a metallic, conductive, or superconducting element 2 placed in front of the output of element 1, separated from each other by another lateral element 2 in the form of a dielectric (FIG. 3.8)). The lateral dielectric element 2, placed between the element 1 and the front conducting element 2, does not obstruct the emitted waves due to its lateral placement, but serves the purpose of functioning as a dielectric waveguide (it could be a dielectric cylinder with a hole in the middle) from element 1 to the front metallic element 2 (which could be a conductive disc). In this way, we increase operating efficiency due to high quality or amplification factors associated with the resonances generated in the system. In this case we will not need to use an element 3 between element 1 and element 2, but element 3 can be used optionally (FIG. 3.9)). The conductive front element 2 may have any dimension relative to the lateral dielectric element 1 and lateral element 2. For example, the front conductive element 2 may have a similar width to the dielectric side element 2 (FIG. 3.8)), or the front conductive element 2 may have the same external diameter as element 1 and the same diameter of the internal hole of dielectric element 2 side or front and can be fixed to it (FIG. 3.10)). The dielectric element 2 lateral to the front conducting element 2 or between the latter and element 1, may also function as a dielectric lens 3, as happens in optical fibers, focusing the electromagnetic pulses coming from element 1 by the gradient of the spatial dielectric constant of the element dielectric 2 or lens 3. A simple whole dielectric block 2 or 3 with a linear or non-linear gradient of the dielectric constant within it perpendicular to the propagation of the pulses, or a dielectric block 2 or 3, with a linear or non-linear dielectric constant, with a hole in the middle can serve as a focusing element. Although we have referred to a specific case of the lens 3 being lateral or frontal to the conductive element 2, any other type of lens 3 can be used in this position. We can therefore use a lens 3 at the output of element 1 together or separately from the option of using another lens 3 lateral or in front of the conductive element 2, or we can use any of these lenses 3 separately, or also not use any lens 3 (FIGS. 3.10) to 3.12)).

We can use any number of lateral repetitions of the system presented in FIGS. 3.8) to 3.10), where for example, we can have two or more lateral repetitions of elements 1 with conducting frontal elements 2, separated by lateral or frontal dielectric elements 2 or 3, where the element 2 conducting front element may be individually applied isolated from other side conductor 2 elements (FIG. 3.11)), or the same conductor front element 2 may be shared by several elements 1 and/or 3 (FIG. 3.12)), or several individual conductor front 2 elements may be in lateral electrical contact with each other, or separated by a dielectric 2 or lens 3. Additionally, each conducting front element 2 may be electrically neutral or electrically charged at a constant or approximately constant voltage or potential (positive or negative), where the latter possibility could significantly increase the force generated using in this case principles similar to U.S. Pat. No. 10,144,532 but making use of longitudinal waves in our case instead of transverse waves as in the aforementioned patent. An example of application could be to use the systems in FIGS. 3.1) to 3.12) placed around a mass 4 with any shape (triangular for example) in order to control the force vectors in any direction (FIG. 3.13)).

In the configurations of FIGS. 3.3) to 3.12) we considered that element 1 is simply a conductor (waveguide with an open end or a resonant metallic box) partially or completely closed on itself, such as a hollow cylinder or metallic box with the dielectric 2 inside. By subjecting element 1 to voltage pulses, by direct electrical connection or using an antenna inside element 1 (FIGS. 3.3) to 3.6)) or using a waveguide coupled to a resonant metal box (FIG. 3.7)), with the appropriate frequency, it will generate longitudinal electric or magnetic waves inside it, and will behave as a frequency resonance amplifier, being able to generate asymmetric pulses of electric or magnetic field inside it that generate propulsion forces in elements 1 and 2, where element 2 may be inside (FIGS. 3.3) to 3.7)) or outside (FIGS. 3.8) to 3.12)) of element 1. For example, by placing a solid dielectric 2 inside a waveguide 1 (FIG. 3.5)) we will multiply the force generated in this element according to Equation (13).

The configurations shown in FIGS. 1 to 5 were designed as if element 1 were a waveguide, which can internally propagate and externally emit both electrical longitudinal waves and magnetic longitudinal waves, but in practice, element 1, or field emitter longitudinal electromagnetic fields 1, may be constituted by a wide variety of different systems capable of emitting longitudinal electric or magnetic fields, including waveguides, resonant boxes or cavities, Maser's or stimulated microwave amplifiers, Laser's or stimulated light amplifiers, plasma antennas or radiation emitters using plasma in all its variety, as well as all types of diverse antennas that act as emitters of pulsed electrical or magnetic waves in space, such as electrical/magnetic impulse antennas that make use of parabolic reflectors, or magnetic potential vector antennas, including all types of transverse electromagnetic wave antennas that can be transformed into longitudinal waves also by element 3, and also including other emitters of longitudinal electric or magnetic waves in space existing in the literature but not mentioned here and which operate at any frequency or repetition rate.

Element 2 may be a material or composition of several dielectric, and/or conductive, and/or magnetic materials, and/or any other material. If a dielectric is used for element 2, then it may be made up of any solid material, liquid or gaseous, which may have a positive or negative permittivity, linear or non-linear, which will influence the direction and magnitude of the generated force, or even be the vacuum itself or a gas at low or high pressure. The dielectric used in element 2 may be pure or be a symmetric or asymmetric mixture of several different dielectrics and may optionally contain embedded within it any number of small conductive, semiconductor, or non-conductor particles of positive or negative permittivity or permeability, linear or non-linear, such as metallic powder or paint, or magnetic, or semiconductor or other. Element 2 may include the use of piezoelectric, or pyroelectric, or ferroelectric, or metamaterials, or glasses, or quartz, or ceramics, or plastics or any other type of dielectric.

On the other hand, we can also use any conductive, superconductor or semiconductor material for element 2, where the conductive material may be neutrally charged or may be electrically charged in any constant electrical polarity. This last detail could increase the magnitude of the force generated because the electrical charge present on the surface of the conductive material will be accelerated by the asymmetrically pulsed longitudinal electric or magnetic fields, being able to generate and emit electric or magnetic fields of greater amplitude through resonance. Optionally, we may wrap the external surface of the used conductor with a dielectric, or we may paint the used conductor with small conductive, non-conductive, semi-conductive or magnetic particle paint in order to increase its total capacitance or improve its properties. Element 2 may be continuous and uniform or on the contrary it may be segmented into smaller conductive sections that are electrically connected or independent of each other.

Element 2 may also be any pure and uniform magnetic material or be a symmetric or asymmetric mixture of one or more different magnetic materials, and/or dielectrics, and/or conductors. Including any magnetic material with positive or negative, linear or non-linear relative magnetic permeability, such as permanent magnets, or conductive or non-conductive ferromagnetic or ferrimagnetic cores, or ferrofluids, among other possibilities, that is, any combination of magnetic materials in the solid state, and/or liquid, and/or gas, which can be conductive or non-conductive, and with any type of particle or nano-particle in suspension, conductive, non-conductive, semi-conductive, magnetic or any other. The magnetic material used for element 2 may not be magnetized, or it may be naturally magnetized, or coils (not shown) may be used to generate a constant or variable magnetization of greater magnitude of the magnetic material.

We can also use for element 2 any composite materials from metallic matrices, and/or composite materials from ceramic matrices, and/or composite materials from carbon matrices, and/or composite materials from polymer matrices, among many other possibilities.

A simple system for remotely manipulating element 2 (which in this case is not mechanically fixed to element 1), also generally designated as mass 4, is constituted by the emitter of longitudinal electromagnetic waves 1, which are optionally focused, amplified or synchronized by element 3 before reaching element 2 or mass 4. In this case, force is generated in elements 2 and 4 in both directions longitudinal to the propagated electric or magnetic field (FIG. 4.1)). Elements 1 and 3, together, function as a force beam, capable of pulling or pushing elements 2 and 4 at a distance, in relation to elements 1 and 3.

To facilitate the manipulation or control of elements 2 and 4 in a given direction, we can use elements 1 and 3 arranged and aligned with each other, placed to the left and right of elements 2 and 4 (FIG. 4.2)). To control elements 2 and 4 in two different directions and perpendicular to each other, we can use a cross distribution of three or four elements 1 and 3 around elements 2 and 4 (FIG. 4.3)). Just as we can use any number of elements 1 and 3 placed, two-dimensionally or three-dimensionally, externally around elements 2 and 4, in order to control the direction of the force and manipulation generated in any two-dimensional or three-dimensional direction. Additionally, we can also use groups of elements 1 and 3 around elements 2 and 4 (FIGS. 4.4) and 4.5)), in any desired direction, in order to improve the resolution of the control obtained and also its efficiency.

All manipulation configurations (FIG. 4) can also be used for energy applications using any number of elements 1 and 3, with preference for the use of six elements or groups of elements 1 and 3, where each unit or group is arranged in each one of the six perpendicular and opposite directions as in the six surfaces or faces of a virtual cube, arranged around mass 4 which could be nuclear fuel (FIGS. 4.3) and 4.5)), where all elements 1 and 3 emit a repulsive force field of equal magnitude to the focus or center where mass 4 is, generating and simultaneously containing nuclear fusion reactions, releasing energy that can be captured and accumulated using known technology.

The element 2 and 4 manipulation system (FIG. 4) uses elements 1 and 3 arranged externally at a distance around elements 2 and 4, where only these last elements, 2 and 4, move. For propulsion purposes the opposite occurs, that is, elements 1 and 3 are arranged and used directly inside or on the surface of a mass 4, with the longitudinal electromagnetic fields directed towards the outside of mass 4 where the surface of mass 4 may be constituted by element 2, or alternatively, element 2 may not be the external surface of mass 4 but placed in any other position within mass 4 together with elements 1 and 3, in order to generate propulsion forces throughout the assembly (FIG. 5).

We can use a pair of elements 1 and 3 arranged in opposite positions inside and around a mass 4, emitting longitudinal electromagnetic fields towards the surface of mass 4, which could be constituted by element 2, in order to generate propulsion forces (FIG. 5.1)). By using two pairs of elements 1 and 3, in a cross-shape, in opposite positions inside and around mass 4, we can control the propulsion forces in two different perpendicular directions (FIG. 5.2)).

Instead of using elements 1 and 3 operating separately in a single direction, we can use groups of two, three or more sets of elements 1 and 3 emitting longitudinal waves in the same direction. In this case (FIGS. 5.3) to 5.6)) and also in previous cases, elements 1 and 3 may be physically fixed, or they may move or rotate on themselves using a central point, in order to facilitate control of the force generated by the interference and intersection of two, three or more beams of longitudinal waves. The advantage of controlling the interference of several beams of longitudinal waves will be that we can easily control the magnitude or direction of the force generated, without varying the applied power. Moving the beams away from each other decreases the force generated in a given direction or changes its direction, while the approximation or convergence of the various beams at a single focal point increases the force generated exponentially, using the phenomenon of “phasing” where the phases of the longitudinal waves are synchronized, exponentially multiplying the energy and output power, according to the square of the number of emitters.

In this way, we can use any number of elements 1 and 3, inside and around a mass 4, which can be fixed or on the contrary be movable linearly, laterally or rotationally, in order to generate directional forces on elements 1, 2 and 4, in a horizontal direction (FIG. 5.3)), or vertical (FIGS. 5.4) to 5.6)). We can, for example, use three longitudinal wave emitters 1, together or not with elements 3, in the lower section of a mass 4 directed downwards in order to control vertical forces (FIGS. 5.4) to 5.6)), where the upper section of mass 4 may contain a single set of elements 1 and 3 pointed towards the surface or exterior of mass 4, or element 2 (FIG. 5.4)), or where the upper section of mass 4 may contain three sets of elements 1 and 3 pointed towards the exterior of mass 4 (FIG. 5.5)), or where the upper section of mass 4 may not contain any element 1 or 3, these being only in the lower section of mass 4 (FIG. 5.6)). Total control of mass 4 can only be achieved with three elements 1 and 3 in the lower area of the mass, where the focusing of these elements downwards, converging the longitudinal waves at a focal point, generates forces of high magnitude in the vertical direction (FIG. 5.6)), and where the rotational deviation of the two external or lateral elements 1 and 3 to a horizontal direction manages to redirect part of the force generated in the horizontal or lateral direction as well, simultaneously decreasing the magnitude of the vertical force (FIG. 5.5)).

The various elements 1 and 3 arranged within or on the surface of mass 4 may also be used to manipulate any other mass external to mass 4. Applications include the generation of force beams external to mass 4 in order to attract or repel any external object to the interior or exterior of mass 4, i.e., use as traction or repulsion beams. We can generate protective force fields around mass 4, where any object that approaches mass 4 will be strongly repelled, with total strength given by Equations (13) and (25) where V will be the volume of the object considered. Applications of the force fields generated in this way are numerous and include the reduction of atmospheric or water friction, allowing the movement of ships in space, in the atmosphere or in water, in a completely protected manner and free from collisions with masses. As an example of the application of the generated force fields, we have the repulsion, attraction or deflection of space debris or asteroids. Another application will be the extinguishing of any type of fire simply using the forces generated by the force fields by the approach of an aerial ship that uses a propulsion system such as the one reported in this patent, which generates force fields at a distance and with a large volume.

It will be possible to teleport the complete mass 4 and/or element 2 individually, respectively in the propulsion configurations (FIG. 5) or in the manipulation configurations (FIG. 4), as long as a single pulse of extremely high magnitude, E·∂E/∂t, or B·∂B/∂t, or H·∂H/∂t, above a given transition value. The teleportation generated will be in the same vectorial direction as the total “space warp” force, Equations (13) and (25), where the distance covered in a single teleportation “jump/leap” will depend on the total magnitude of the pulse used. Note that in the manipulation configurations (FIG. 4) elements 1 and 3 remain where they are and only mass 4 and/or element 2 will be manipulated or teleported due to the distance of elements 1 and 3 in relation to the zone of great deformation of space-time where elements 2 and 4 are. In the propulsion configuration (FIG. 5) the entire set including elements 1, 2, 3 and 4 will be teleported due to their mutual proximity in relation to the zone or focus of space-time deformation. In the manipulation configuration (FIG. 4) elements 2 or 4 are not fixed or mechanically attached to elements 1 and/or 3, and in the propulsion configuration (FIG. 5), elements 2 and 4 are mechanically fixed to elements 1 and/or 3.

All configurations shown in FIGS. 1, 2 and 3 represent propulsion units 5, which can be independent or on the contrary be connected to each other in any distribution or grid. We can also use in all propulsion units 5 any power source, high or low voltage or current, constant, pulsed or any other, including asymmetric pulses or with an asymmetric voltage or current derivative. Examples of non-limiting power supplies include Marx generators, inductive voltage or current pulse generators, microwave generators with asymmetric voltage or current pulses, among many other options.

In order to illustrate some preferred and non-limiting applications of the propulsion units 5 discussed previously we now illustrate some concepts in FIG. 6. We can use a uniform distribution of propulsion units 5 around the periphery of mass 4, in order to control the horizontal or vertical direction of the propulsion forces (FIGS. 6.1) to 6.3)). In these cases, we also use several propulsion units 5 distributed in triangular (FIG. 6.1)), or hexagonal (FIG. 6.2)), or circular (FIG. 6.3)) patterns along the upper, lower, or side surfaces. Any uniform or non-uniform pattern in the distribution of propulsion units 5 may be used. Instead of using some propulsion units 5 at specific points of the mass or ship 4 that we want to move, we can make the entire ship or mass 4 a gigantic propulsion unit, using any of the propulsion units 5 shown, and the occupants may be protected from electromagnetic fields if they are inside a Faraday cage or metal enclosure.

As illustrated, any desired shape for the ship or mass 4 can be used (FIG. 6). The only important factor is the use of one or more propulsion units 5 in order to control the propulsion direction, which can be on the surface/periphery of mass 4 or immersed in any position within it. Other variations to be considered will be independent vertical, diagonal or horizontal parts of the ship or mass 4 which may contain propulsion units 5 and be movable and tiltable in any direction. All the variations discussed can be applied to motorbikes, cars, flying skateboards, submarines, planes, ships, drones, flying platforms in any environment, personal transport like “Jet Pack” on the back or motorbikes and flying cars, among many other application possibilities related and not mentioned.

1. Electromagnetic propulsion system, characterized by the use of one or more longitudinal electromagnetic field emitters (1), optionally used in conjunction with one or more elements (3), placed inside or on the surface of a mass (4), where element (1) emits longitudinal electric or magnetic fields, pulsed with asymmetric temporal derivative of the electric E or magnetic B field, that is, with the asymmetric product E·∂E/∂t or B·∂B/∂t, which propagates through space in the direction of element (2), which is located away from elements (1) and (3), but mechanically fixed at a certain distance from them, where the pulses may be emitted with any magnitude or repetition rate, including the application of pulses of extreme magnitude.

2. Electromagnetic propulsion system, according to claim 1, characterized by the use of elements (1) and (3) arranged and used directly inside or on the surface of a mass (4), with the longitudinal electromagnetic fields directed towards the outside of mass (4) where the surface of mass (4) may be constituted by element (2), or the element (2) may not be the external surface of mass (4) but placed in any other position within mass (4) together with elements (1) and (3); where element (2) may be at any distance from elements (1) or (3), including in physical contact with element (1) or (3), and may even be mechanically supported by elements (1) or (3) directly or indirectly.

3. Electromagnetic propulsion system, according to claim 1, characterized by the use of any number of elements (1) and (3), inside or on the surface of a mass (4), in any arrangement, which can be fixed or on the contrary, they are movable linearly, laterally or rotationally in any direction; including for example, the use of a pair of elements (1) and (3) arranged in opposite positions within and/or around a mass (4), emitting longitudinal electromagnetic fields towards the surface of mass (4), which may be constituted by element (2); or where we can use two pairs of elements (1) and (3) in opposite positions inside and/or around a mass (4), in the shape of a cross; or where we may use any number of opposing pairs of elements (1) and (3), in any position within or on the surface of mass (4).

4. Electromagnetic propulsion system, according to claim 1, characterized by the use of elements (1) and (3) operating separately in a given direction, or by the use of groups of two, three or more sets of elements (1) and (3) emitting longitudinal waves in the same direction; where again elements (1) and (3) may be physically fixed, or they may move or rotate on themselves using a focal point, where we may converge several beams on a single focal point in a fixed or temporary way; where we can use three longitudinal wave emitters (1), together or not with elements (3), in the lower section of a mass (4) directed downwards; where the upper section of mass (4) may contain a single set of elements (1) and (3) pointed towards the surface or exterior of the mass (4) or element (2); or where the upper section of mass (4) may contain three sets of elements (1) and (3) pointing towards the outside of mass (4); or where the upper section of mass (4) may not contain any element (1) or (3), these being only in the lower section of mass (4).

5. Electromagnetic propulsion system, according to claim 1, characterized by the use of element (2) outside or inside element (1), where in the latter case, element (2) may be completely surrounded by element (1), or partially enclosed, with only a small opening on one of the faces of element (1), or where one of the faces of element (1) may be completely open, or where element (2) may be inserted inside element (1) only partially, and can adapt its dimensions to be mechanically supported by element (1) or (3), and where element (2) can be differentiated, that is, the interior of element (1) may have a solid element (2) next to another gaseous, vacuum, liquid, or solid lateral element (2) where the various components of elements (1) and/or (2) may have similar or different linear dimensions along of its extension.

6. Electromagnetic propulsion system, according to claim 1, characterized by the use of an element (1) emitting asymmetric longitudinal pulses in the direction of a metallic, conductive or superconducting element (2) placed in front of the exit of element (1), separated from each other by another lateral element (2) or (3) in the form of a dielectric, which functions as a dielectric waveguide, which could be, for example, an entire dielectric cylinder (2) or (3) with a gradient linear or non-linear dielectric constant inside it perpendicular to the propagation of the pulses, or a dielectric block (2) or (3), with linear or non-linear dielectric constant, with a hole in the middle, from element (1) to the front metallic element (2), which may be a conductive or superconducting disc; where we can optionally use element (3) between element (1) and conductive front element (2); where the conductive front element (2) may have any dimension relative to the side or front dielectric element (1) and element (2) or (3), for example, the conductive front element (2) may have a width similar to dielectric lateral element (2) or (3), or the conductive front element (2) may have the same external diameter as element (1) and the same diameter of the internal hole of the lateral dielectric element (2) or (3), and may be fixed to them, among other possibilities; where we can use any type of lens (3) at the exit of element (1) in a lateral or frontal position to conductive element (2); or where we may use any number of lateral repetitions of elements (1) with conductive front elements (2), separated by lateral or frontal dielectric elements (2) or (3), where the conductive front element (2) may be of individual application isolated from other side conductor elements (2), or the same front conductor element (2) may be shared by several elements (1) and/or (3), or where several individual front conductor elements (2) may be in electrical contact lateral to each other, or separated by a dielectric; where each conducting front element (2) may be electrically neutral or electrically charged in either polarity at a constant or approximately constant voltage or potential.

7. Electromagnetic propulsion system, according to claim 1, characterized by element (1), or emitter of longitudinal electromagnetic fields (1), which can propagate internally and emit externally both electrical longitudinal waves and magnetic longitudinal waves, may consist of a wide variety of different systems capable of emitting longitudinal electric or magnetic fields, including open-ended waveguides, resonant boxes, cylinders or cavities, Maser's or stimulated microwave amplifiers, Laser's or stimulated light amplifiers, plasma antennas or radiation emitters using plasma in all its variety, as well as all types of diverse antennas that act as emitters of pulsed electrical or magnetic waves in space, such as electric or magnetic impulse antennas that make use of parabolic reflectors, or magnetic potential vector antennas; where we can use all types of transverse electromagnetic wave antennas that can be transformed into longitudinal waves by element (3); or where, element (1) may simply be a conductor, waveguide or resonant metallic box, partially or completely closed on itself, such as a hollow cylinder or metallic box with element (2) inside, and subjecting element (1) to voltage pulses, by direct electrical connection or use of an antenna inside element (1), or using a waveguide coupled to a resonant metal box; where we can also use other emitters of longitudinal electric or magnetic waves in space existing in the literature but not mentioned here and which operate at any frequency or repetition rate.

8. Electromagnetic propulsion system, according to claim 1, characterized by element (2) being a single material or composition of several dielectric, and/or conductive, and/or magnetic materials, where if a dielectric is used for element (2) then it can be made up of any solid, liquid or gaseous material, and can have a positive or negative permittivity, linear or non-linear, or even be the vacuum itself or a gas at low or high pressure, where the dielectric used in element (2) may be pure or a symmetric or asymmetric mixture of several different dielectrics and may optionally contain embedded within it any number of small conductive, or semiconductor, or non-conductor particles of positive or negative permittivity or permeability, linear or non-linear, such as metallic powder or paint, or magnetic, or semiconductor or other; where element (2) may include the use of piezoelectric, or pyroelectric, or ferroelectric, or metamaterials, or glasses, or quartz, or ceramics, or plastics or any other type of dielectric.

9. Electromagnetic propulsion system, according to claim 1, characterized by element (2) being any conductive, superconductor or semiconductor material, where the conductive material may be neutrally charged or may be electrically charged in any constant electrical polarity; where we may optionally wrap the outer surface of the used conductor with a dielectric, or we may paint the used conductor with paint of small conductive, non-conductive, semi-conductive, or magnetic particles; and where element (2) may be continuous and uniform or on the contrary may be segmented into smaller conductive sections that are electrically connected or independent of each other.

10. Electromagnetic propulsion system, according to claim 1, characterized by element (2) may also be any pure and uniform magnetic material, or be a symmetric or asymmetric mixture of one or more magnetic and/or dielectric materials, and/or different conductors, including any magnetic material with positive or negative relative magnetic permeability, linear or non-linear, such as permanent magnets, or conductive or non-conductive ferromagnetic or ferrimagnetic cores, or ferrofluids, among other possibilities, that is, any combination of magnetic materials in the solid, and/or liquid, and/or gaseous state, which can be conductive or non-conductive, and with any type of particle or nano-particle in suspension, conductive, non-conductive, semi-conductive, magnetic or any other; where the magnetic material used for element (2) may not be magnetized, or may be naturally magnetized, or coils may be used to generate a constant or variable magnetization of greater magnitude of the magnetic material; and where element (2) may be constituted by any composite materials of metallic matrices, and/or composite materials of ceramic matrices, and/or composite materials of carbon matrices, and/or composite materials of polymer matrices, among many other possibilities.

11. Electromagnetic propulsion system, according to claim 1, characterized by the optional use of an element (3), placed at the exit or close to the exit of element (1), where element (3) may assume a large variety of functions including the general function of amplifying longitudinal waves; or element (3) may function as an electromagnetic lens dispersing or on the contrary focusing the longitudinal electrical or magnetic waves into a well-defined beam with controlled aperture, focus, and dispersion; or where element (3) can control the phase of the emitted longitudinal waves; or where element (3) may also transform transverse electromagnetic waves into longitudinal ones, if transverse waves are emitted by element (1).

12. Electromagnetic propulsion system, according to claim 1, characterized by the use of one or more power sources, of high or low voltage or current, constant, pulsed, or any other, including asymmetric pulses or with voltage or current derivative asymmetric, such as non-limiting, Marx generators, inductive voltage or current pulse generators, microwave generators with asymmetric voltage or current pulses, among many other options, using any repetition rate of the applied voltage or current pulses, and connected to one or more elements (1), and optionally to one or more elements (2), or connected to coils used in the optional magnetization of element (2).

13. Electromagnetic propulsion system according to claim 1, characterized by the use, independently or in conjunction, of any of the propulsion units (5) fixed to a mass (4) or part of that mass (4), which has any shape, and distributed around its periphery, or in any other desired position, within or on the surface of mass (4), in any number, pattern or arrangement, where we can also make the ship or mass (4) itself a gigantic propulsion unit, using any of the propulsion units (5), where mass (4) may have independent vertical, diagonal or horizontal parts, which may contain propulsion units (5), which may be movable and tiltable in any direction.

14. System for generating fields or force beams, according to claim 1, characterized by the use of one or more elements, or sets of elements (1), optionally used with one or more elements (3), arranged inside or surface of mass (4), with emission of longitudinal electric or magnetic fields, with asymmetric pulses or with asymmetric temporal derivative of the electric or magnetic field, towards the outside of mass (4) in the direction of external masses (4).

15. Electromagnetic manipulation system, according to claim 1, characterized by the use of one or more emitters (1), optionally used with one or more elements (3), placed outside and at a distance from a mass (4) or element (2), which is not mechanically fixed to elements (1) and/or (3), where elements (1) and/or (3) emit asymmetrically pulsed longitudinal electric or magnetic fields or with an asymmetric electric or magnetic field derivative, through space in the direction of element (2) or (4), where pulses may be emitted with any magnitude or repetition rate, including the application of pulses of extreme magnitude.

16. Electromagnetic manipulation system, according to claim 15, characterized by the use of any number of elements (1) and (3), or groups of elements (1) and (3), placed in planes of two or three dimensions at a distance and around one or more masses (4), or one or more elements (2), in any configuration to manipulate or control mass (4) or element (2), in any two-dimensional or three-dimensional direction; including, for example, the use of a single element (1) and (3) placed at a distance from elements (2) and (4); or including the use of elements (1) and (3) arranged and aligned with each other, placed to the left and right of elements (2) and (4); or including the use of four elements (1) and (3) around elements (2) and (4) arranged crosswise around mass (4) or element (2); or including the use of groups of elements (1) and (3) around elements (2) and (4), in any direction or organization.

17. Electromagnetic manipulation system, according to claim 15, characterized by all mentioned configurations can be used for energy applications using any number of elements (1) and (3) around mass (4), with preference for the use of six elements or groups of elements (1) and (3), arranged symmetrically in each of the six perpendicular and opposite directions as in the six surfaces or faces of a virtual cube, arranged around mass (4) that could be nuclear fuel in this case, where the energy generated can be captured and accumulated using known technology.
